(19) United States
(12) Patent Application Publication
(10) Pub. No.: US 2019/0336379 A1
(43) Pub. Date: Nov. 7, 2019

(54) REHABILITATION EQUIPMENT

(71) Applicant: HIWIN TECHNOLOGIES CORP., Taichung City (TW)

(72) Inventors: Wen-Bin Lin, Taichung City (TW); Ming-Hsu Mao, Taichung City (TW)

(21) Appl. No.: 15/972,290

(22) Filed: May 7, 2018

(51) Int. Cl. A61H 1/02

(52) U.S. Cl. CPC A61H 1/0266; A63B 23/0417

(57) ABSTRACT

A rehabilitation equipment includes a left foot pedal, a right foot pedal, a left-pedal driving module to drive movement of the left foot pedal, and a right-pedal driving module to drive movement of the right foot pedal. The rehabilitation equipment measures forces output by the left-pedal driving module and the right-pedal driving module when a user is at a relaxing state and also when the user is at an exercising state, thereby obtaining information relating to forces voluntarily output by the left foot and the right foot of the user.

### FIELD

The disclosure relates to a passive training equipment, and more particularly to a rehabilitation equipment.

### BACKGROUND

Taiwanese Patent No. 1262092 discloses a system for adjusting a belt speed of an electric treadmill based on a time difference between electric-current loads generated by treading steps of the user on the belt, so as to cause the belt speed to approach the walking or running speed of the user.

However, a rehabilitation equipment is different from an ordinary training equipment such as a treadmill, and requires more information to assess the effectiveness of rehabilitation, and/or to motivate the user to perform voluntary movement during rehabilitation.

### SUMMARY

Therefore, this disclosure provides a rehabilitation equipment that implements a method for assessing voluntary movement of a user during rehabilitation.

According to the disclosure, the rehabilitation equipment includes a left foot pedal for operation by a left foot of the user, a left-pedal driving module to drive movement of the left foot pedal for guiding the left foot of the user to take a step, a left-pedal measuring module mounted to the left-pedal driving module, a right foot pedal for operation by a right foot of the user, a right-pedal driving module to drive movement of the right foot pedal for guiding the left foot of the user to take a step, a right-pedal measuring module mounted to the left-pedal driving module, and a processing module electrically connected to the left-pedal measuring module and the right-pedal measuring module.

The method implemented by the rehabilitation equipment includes steps of: measuring, by the left-pedal measuring module and the right-pedal measuring module during a first time period which has a length equaling that of a measuring cycle and in which both of the left foot of the user on the left foot pedal and the right foot of the user on the right foot pedal are at a relaxing state, the force output by the left-pedal driving module to generate first left-pedal force information corresponding to the first time period, and the force output by the right-pedal driving module to generate first right-pedal force information corresponding to the first time period; measuring, by the left-pedal measuring module and right-pedal measuring module during a second time period which has a length equaling that of the measuring cycle and in which both of the left foot of the user on the left foot pedal and the right foot of the user on the right foot pedal are at an exercising state, the force output by the left-pedal driving module to generate second left-pedal force information corresponding to the second time period, and the force output by the right-pedal driving module to generate second right-pedal force information corresponding to the second time period; and determining, by the processing module, a difference between the first left-pedal force information and the second left-pedal force information to generate left-foot force output information relating to a force output by the left foot of the user, and determining, by the processing module, a difference between the first right-pedal force information and the second right-pedal force information to generate right-foot force output information relating to a force output by the right foot of the user.

### BRIEF DESCRIPTION OF THE DRAWINGS

Other features and advantages of the disclosure will become apparent in the following detailed description of the embodiment (s) with reference to the accompanying drawings, of which:

FIG. 1 is a perspective view illustrating an embodiment of a rehabilitation equipment used by a user according to the disclosure;

FIG. 2 is a block diagram illustrating the embodiment of the rehabilitation equipment according to this disclosure;

FIG. 3 is a flow chart illustrating an embodiment of steps for obtaining a force output ratio relating to forces output by the feet of the user according to this disclosure;

FIG. 4 shows plots exemplarily illustrating forces output by the rehabilitation equipment during a first time period in which the user is at a relaxing state;

FIG. 5 shows plots exemplarily illustrating forces output by the rehabilitation equipment during a first time period in which the user is at an exercising state;

FIG. 6 shows plots exemplarily illustrating forces output by the user during the second time period, which are calculated based on the plots shown in FIGS. 4 and 5;

FIG. 7 is a flow chart illustrating an embodiment of detailed steps for obtaining the force output ratio;

FIG. 8 is a flow chart illustrating an embodiment of steps of obtaining accuracy of force output by each of the left foot and the right foot of the user during the second period according to this disclosure; and

FIGS. 9 and 10 cooperatively provide a flow chart illustrating an embodiment of steps for calculating an overall step accuracy and a level of voluntary movement of the user during the rehabilitation according to this disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

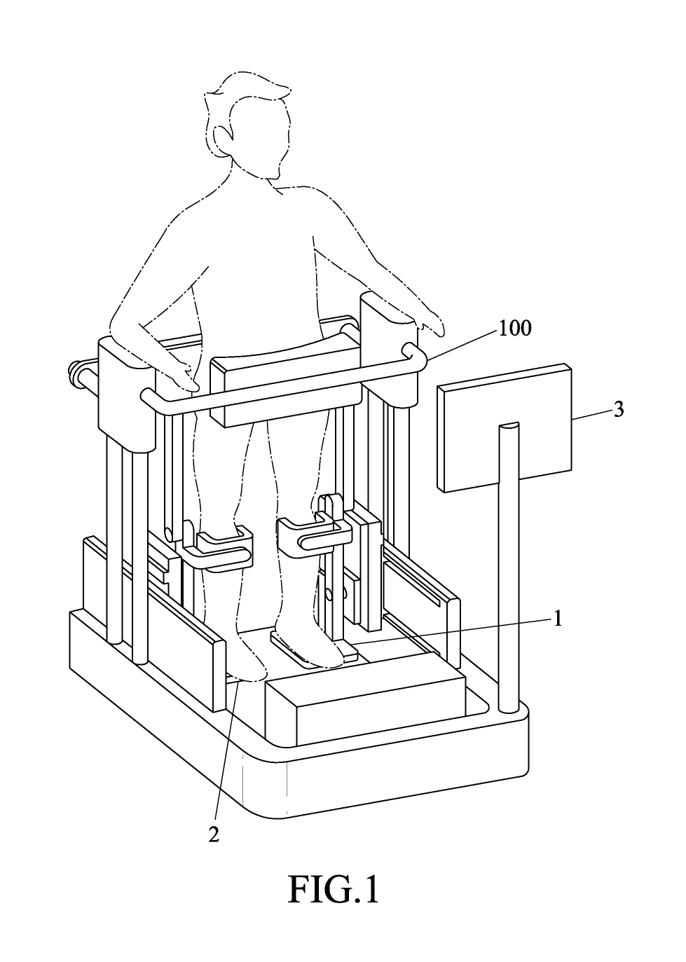

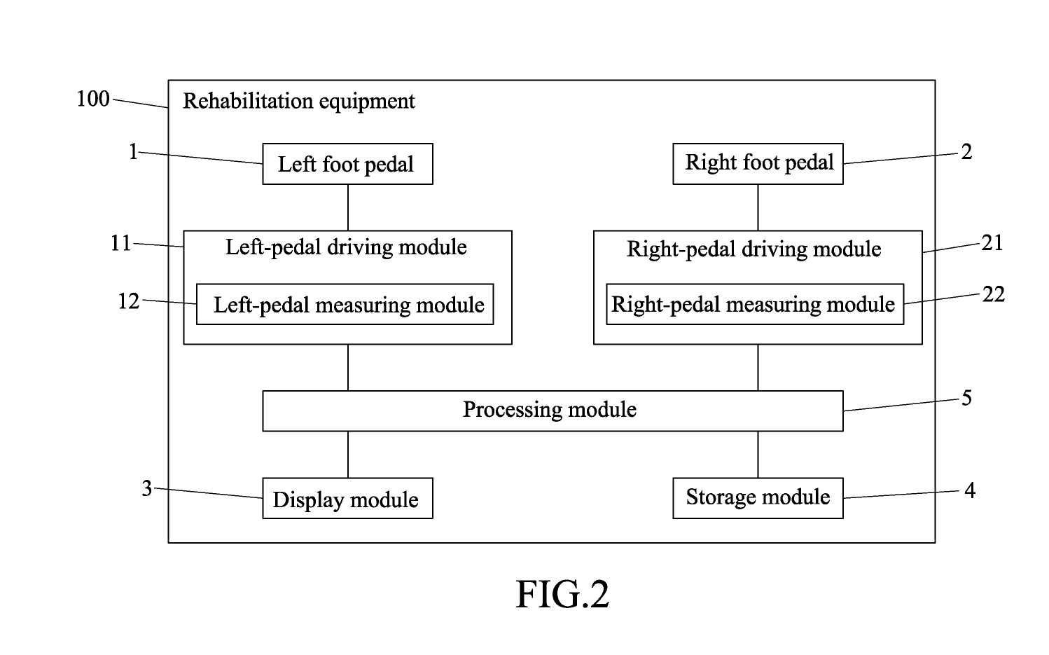

Referring to FIGS. 1 and 2, the embodiment of the rehabilitation equipment 100 according to this disclosure includes a left foot pedal 1 for operation by a left foot of a user, a left-pedal driving module 11 to drive movement of the left foot pedal 1 for guiding the left foot of the user to take a step, a left-pedal measuring module 12 mounted to the left-pedal driving module 11 and configured to measure a force output by the left-pedal driving module 11 to drive movement of the left foot pedal 1, a right foot pedal 2 for operation by a right foot of the user, a right-pedal driving module 21 to drive movement of the right foot pedal 2 for guiding the right foot of the user to take a step, a right-pedal measuring module 22 mounted to the right-pedal driving module 21 and configured to measure a force output by the right-pedal driving module 21 to drive movement of the right foot pedal 2, a display module 3 (e.g., a liquid crystal display device, a light emitting diode display device or the like), a storage module 4 (e.g., a read-only memory, a flash memory, a hard disk drive or the like), and a processing module 5 (e.g., a processor executing an appropriate program) electrically connected to the left-pedal measuring module 12, the right-pedal measuring module 22, the display module 3 and the storage module 4. The processing module 5 may be electrically connected to the left-pedal measuring module 12 and the right-pedal measuring module 22 either by physical wires or by wireless technologies, and this disclosure is not limited in this respect. In this embodiment, the forces output by the left-pedal driving module 11 and the right-pedal driving module 21 may be in a form of rotational forces (torques), but this disclosure is not limited in this respect.

The rehabilitation equipment 100 is configured to assess voluntary movement of the user during rehabilitation, and the assessment includes calculating force output information relating to force output by the left foot and the right foot, calculating a force output ratio between the forces output by the left foot and the right foot, calculating overall step accuracy, and calculating a level of the voluntary movement of the user.

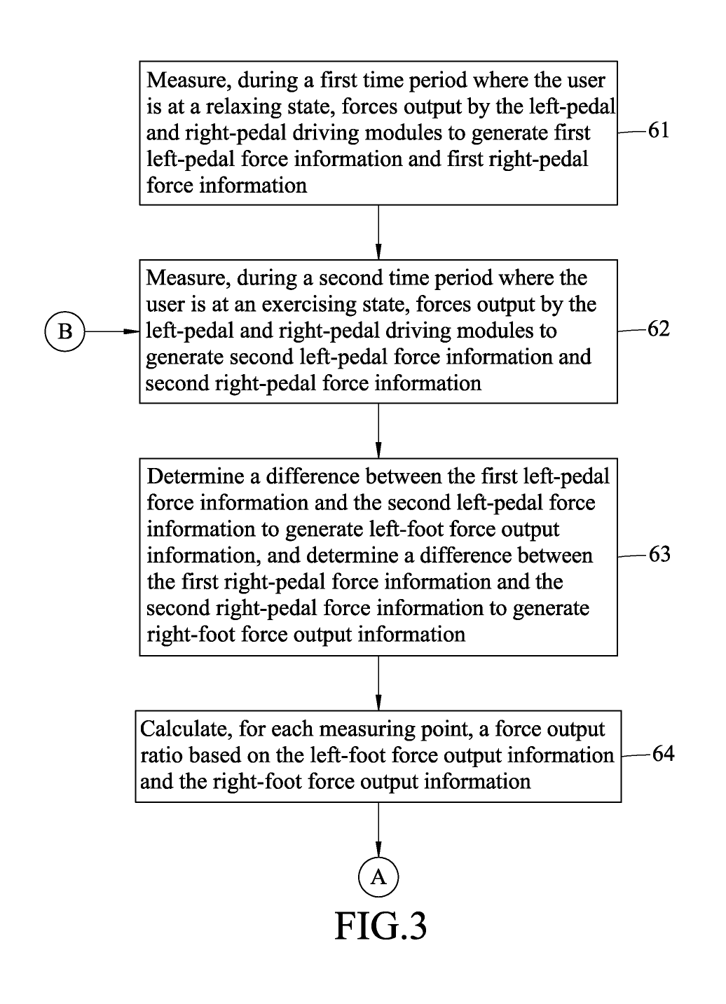

Referring to FIGS. 1 through 3, the rehabilitation equipment 100 performs steps 61 through 64 to calculate the force output information and the force output ratio in this embodiment.

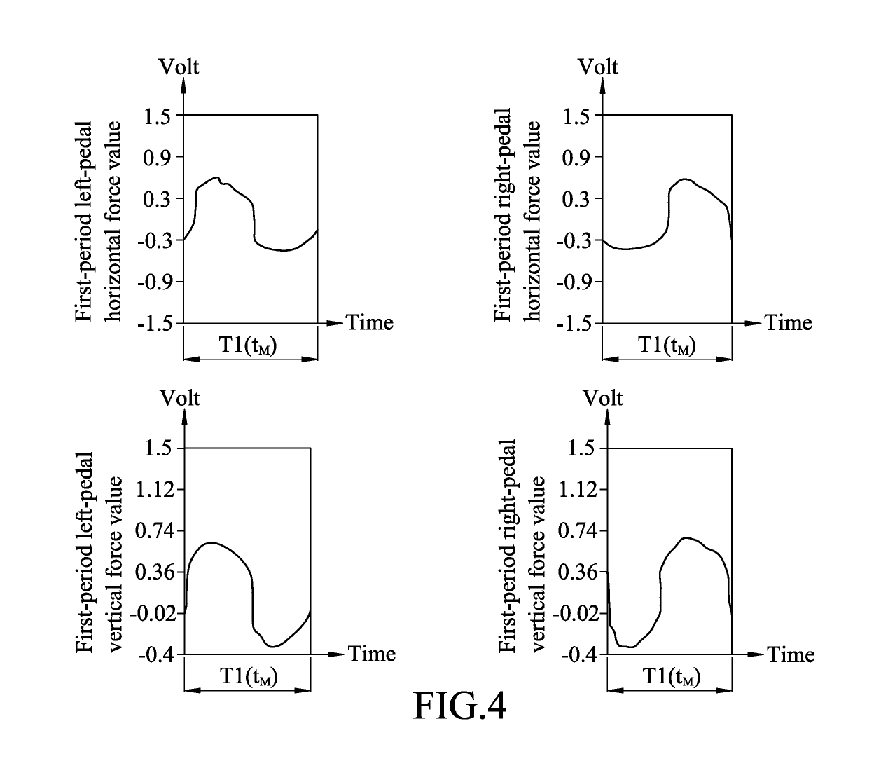

In step 61, while the rehabilitation equipment 100 is operated, with the user having the left foot on the left foot pedal 1 and the right foot on the right foot pedal 2 at a relaxing state (i.e., the user does not intend to move his/her feet to take steps), to have the left-pedal driving module 11 and the right-pedal driving module 21 drive movement of the left foot pedal 1 and the right foot pedal 2, the left-pedal measuring module 12 and the right-pedal measuring module 22 measure, during a first time period which has a length equaling that of a measuring cycle, the force output by the left-pedal driving module 11 to generate first left-pedal force information corresponding to the first time period, and the force output by the right-pedal driving module 21 to generate first right-pedal force information corresponding to the first time period. The first left-pedal force information includes multiple sets of first-period left-pedal force data respectively corresponding to a plurality of measuring points which are points in time defined with respect to the measuring cycle, and the first right-pedal force information includes multiple sets of first-period right-pedal force data respectively corresponding to the measuring points. Each set of the first-period left-pedal force data includes a first-period left-pedal horizontal force value and a first-period left-pedal vertical force value, and each set of the first-period right-pedal force data includes a first-period right-pedal horizontal force value and a first-period right-pedal vertical force value, as shown in FIG. 4, where T1 represents the first time period, and t_{M} represents the length of the first time period.

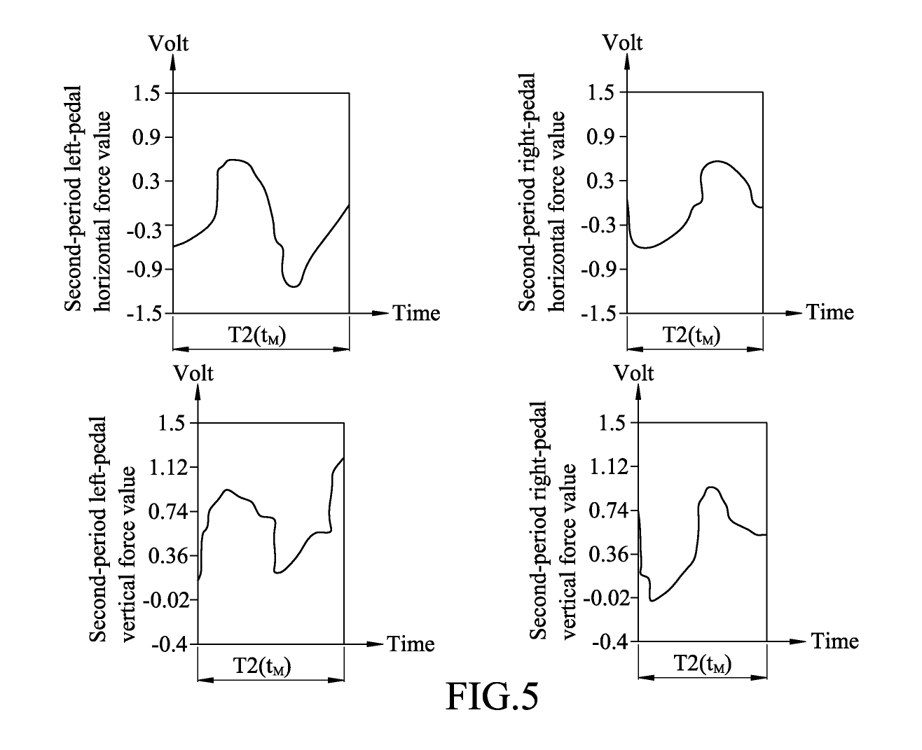

In step 62, while the rehabilitation equipment 100 is operated, with the user having the left foot on the left foot pedal 1 and the right foot on the right foot pedal 2 in an exercising state (i.e., the user intends to voluntarily output forces by his/her feet in order to take steps), to have the left-pedal driving module 11 and the right-pedal driving module 21 assist the user in driving the movement of the left foot pedal 1 and the right foot pedal 2, the left-pedal measuring module 12 and the right-pedal measuring module 22 measures, during a second time period which has a length also equaling that of the measuring cycle, the force output by the left-pedal driving module 11 to generate second left-pedal force information corresponding to the second time period, and the force output by the right-pedal driving module 21 to generate second right-pedal force information corresponding to the second time period. The second left-pedal force information includes multiple sets of second-period left-pedal force data respectively corresponding to the measuring points, and the second right-pedal force information includes multiple sets of second-period right-pedal force data respectively corresponding to the measuring points. Each set of the second-period left-pedal force data includes a second-period left-pedal horizontal force value and a second-period left-pedal vertical force value, and each set of the second-period right-pedal force data includes a second-period right-pedal horizontal force value and a second-period right-pedal vertical force value, as shown in FIG. 5, where T2 represents the second time period, and t_{M} represents the length of the second time period.

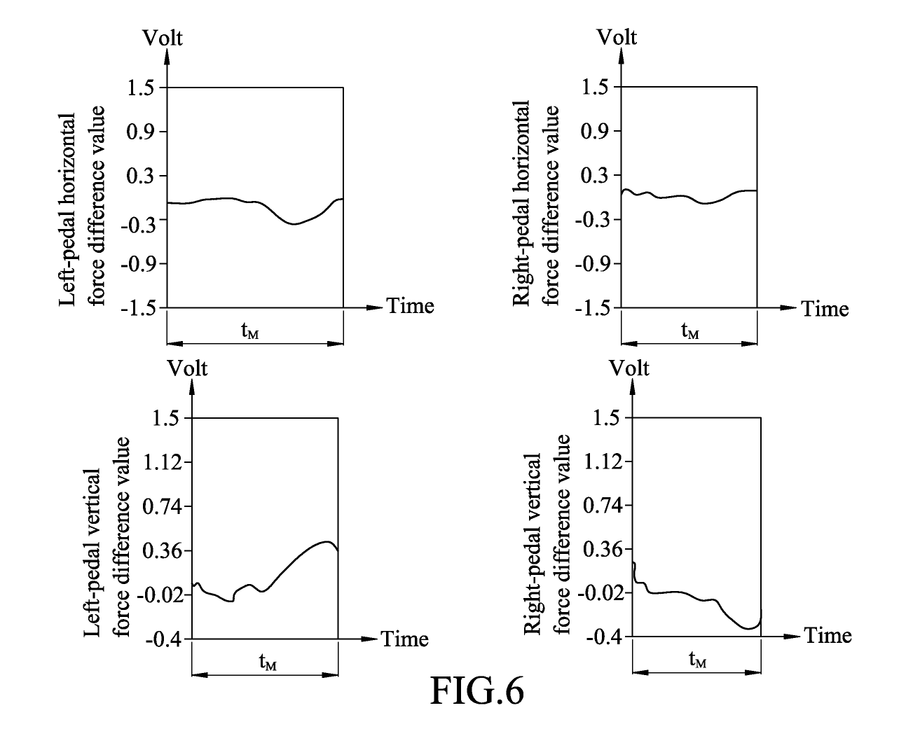

In step 63, the processing module 5 determines a difference between the first left-pedal force information and the second left-pedal force information to generate left-foot force output information relating to a force output by the left foot of the user, and determines a difference between the first right-pedal force information and the second right-pedal force information to generate right-foot force output information relating to a force output by the right foot of the user. The left-foot force output information includes multiple sets of left-pedal force difference data respectively corresponding to the measuring points, and each set of the left-pedal force difference data relates to a difference between one set of the second-period left-pedal force data and one set of the first-period left-pedal force data that correspond to a respective same one of the measuring points. The right-foot force output information includes multiple sets of right-pedal force difference data respectively corresponding to the measuring points, and each set of the right-pedal force difference data relates to a difference between one set of the second-period right-pedal force data and one set of the first-period right-pedal force data that correspond to a respective same one of the measuring points. As shown in FIG. 6, each set of the left-pedal force difference data includes a left-pedal horizontal force difference value and a left-pedal vertical force difference value, and each set of the right-pedal force difference data includes a right-pedal horizontal force difference value and a right-pedal vertical force difference value. In this embodiment, each set of the left-pedal force difference data is obtained by determining a difference between the corresponding set of the first-period left-pedal force data from the corresponding set of the second-period left-pedal force data, and each set of the right-pedal force difference data is obtained by determining a difference between the corresponding set of the first-period right-pedal force data from the corresponding set of the second-period right-pedal force data. In detail, the left-pedal horizontal force difference value of each set of the left-pedal force difference data is obtained by subtracting the first-period left-pedal horizontal force value of the corresponding set of the first-period left-pedal force data from the second-period left-pedal horizontal force value of the corresponding set of the second-period left-pedal force data; the left-pedal vertical force difference value of each set of the left-pedal force difference data is obtained by subtracting the first-period left-pedal vertical force value of the corresponding set of the first-period left-pedal force data from the second-period left-pedal vertical force value of the corresponding set of the second-period left-pedal force data; the right-pedal horizontal force difference value of each set of the right-pedal force difference data is obtained by subtracting the first-period right-pedal horizontal force value of the corresponding set of the first-period right-pedal force data from the second-period right-pedal horizontal force value of the corresponding set of the second-period right-pedal force data; and the right-pedal vertical force difference value of each set of the right-pedal force difference data is obtained by subtracting the first-period right-pedal vertical force value of the corresponding set of the first-period right-pedal force data from the second-period right-pedal vertical force value of the corresponding set of the second-period right-pedal force data.

In step 64, the processing module 5 calculates, for each of the measuring points, a force output ratio based on the corresponding set of the left-pedal force difference data and the corresponding set of the right-pedal force difference data, and causes the display module 3 to display the force output ratio. For each of the measuring points, the force output ratio indicates one of a condition that the left foot of the user applied a force, a condition that the right foot of the user applied a force, and a condition that neither the left foot nor the right foot of the user applied a force.

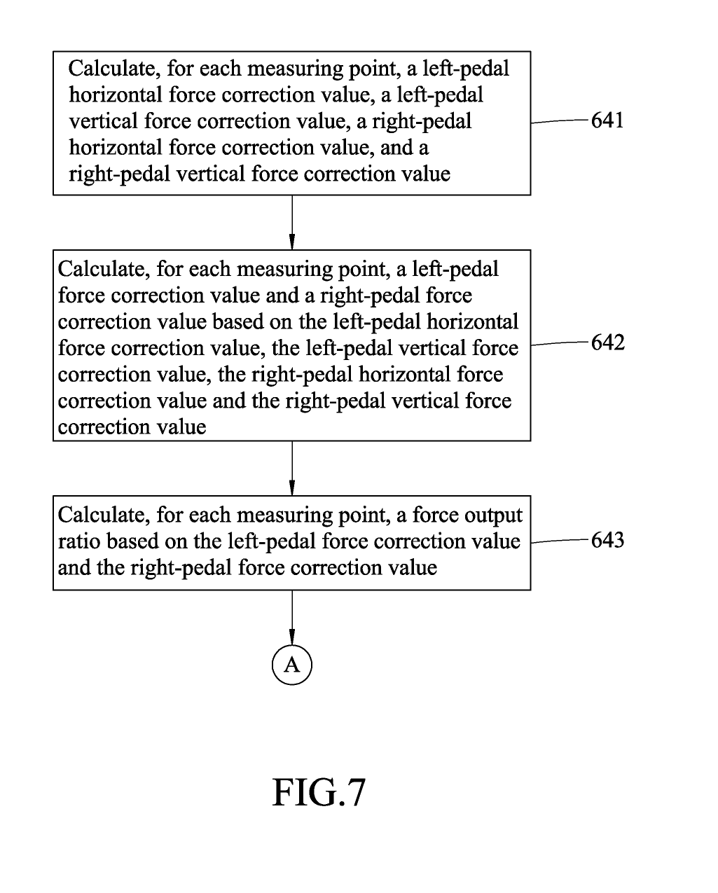

Further referring to FIG. 7, step 64 includes sub-steps 641 through 643.

In sub-step 641, the processing module 5 calculates, for each of the measuring points, a left-pedal horizontal force correction value based on the left-pedal horizontal force difference value that corresponds to the measuring point and a predetermined horizontal force threshold value that corresponds to the measuring point, a left-pedal vertical force correction value based on the left-pedal vertical force difference value that corresponds to the measuring point and a predetermined vertical force threshold value that corresponds to the measuring point, a right-pedal horizontal force correction value based on the right-pedal horizontal force difference value that corresponds to the measuring point and the predetermined horizontal force threshold value that corresponds to the measuring point, and a right-pedal vertical force correction value based on the right-pedal vertical force difference value that corresponds to the measuring point and the predetermined vertical force threshold value that corresponds to the measuring point. It is noted that the predetermined horizontal force threshold value and the predetermined vertical force threshold value may be pre-stored in the storage module 4. The predetermined vertical force threshold value and the predetermined horizontal force threshold value may be useful in excluding the influence caused by signal noise. In this embodiment, the left-pedal horizontal force correction value is calculated according to:

$$\{ \begin{matrix}{P}_{1 , x} = {F}_{1 , x} - 1 & ( {F}_{1 , x} \leq {TH}_{x} ) \\ {P}_{1 , x} = 1 & ( {F}_{1 , x} > {TH}_{x} )\end{matrix} , \qquad ( 1 )$$

where P_{1,x} represents the left-pedal horizontal force correction value, F_{1,x} represents the left-pedal horizontal force difference value, and THₓ represents the predetermined horizontal force threshold value; the left-pedal vertical force correction value is calculated according to:

$$\{ \begin{matrix}{P}_{1 , y} = {F}_{1 , y} + 1 & ( {F}_{1 , y} \geq {TH}_{y} ) \\ {P}_{1 , y} = 1 & ( {F}_{1 , y} < {TH}_{y} )\end{matrix} , \qquad ( 2 )$$

where P_{1,y} represents the left-pedal vertical force correction value, F_{1,y} represents the left-pedal vertical force difference value, and TH_{y} represents the predetermined vertical force threshold value; the right-pedal horizontal force correction value is calculated according to:

$$\{ \begin{matrix}{P}_{r , x} = {F}_{r , x} - 1 & ( {F}_{r , x} \leq {TH}_{x} ) \\ {P}_{r , x} = 1 & ( {F}_{r , x} > {TH}_{x} )\end{matrix} , \qquad ( 3 )$$

where P_{r,x} represents the right-pedal horizontal force correction value, and F_{r,x} represents the right-pedal horizontal force difference value; and the right-pedal vertical force correction value is calculated according to:

$$\{ \begin{matrix}{P}_{r , y} = {F}_{r , y} + 1 & ( {F}_{r , y} \geq {TH}_{y} ) \\ {P}_{r , y} = 1 & ( {F}_{r , y} < {TH}_{y} )\end{matrix} , \qquad ( 4 )$$

where P_{r,y} represents the right-pedal vertical force correction value, and F_{r,y} represents the right-pedal vertical force difference value.

In sub-step 642, the processing module 5 calculates, for each of the measuring points, a left-pedal force correction value based on the left-pedal horizontal force correct ion value and the left-pedal vertical force correction value that correspond to the measuring point, and a right-pedal force correction value based on the right-pedal horizontal force correction value and the right-pedal vertical force correction value that correspond to the measuring point. In this embodiment, the left-pedal force correction value is calculated according to:

S₁=|P_{1,x}|×|P_{1,y}| (5),

where S₁ represents the left-pedal force correction value; and the right-pedal force correction value is calculated according to:

Sᵣ=|P_{r,x}|×|P_{r,y}| (6)

where Sᵣ represents the right-pedal force correction value.

In sub-step 643, the processing module 5 calculates, for each of the measuring points, the force output ratio based on the left-pedal force correction value and the right-pedal force correction value that correspond to the measuring point. In this embodiment, the force output ratio is calculated according to:

$$\{ \begin{matrix}R = ( \frac{{S}_{1}}{{S}_{r}} ) - 1 & ( {S}_{1} \geq {S}_{r} ) \\ R = - ( \frac{{S}_{r}}{{S}_{1}} ) + 1 & ( {S}_{1} < {S}_{r} )\end{matrix} , \qquad ( 7 )$$

where R represents the force output ratio.

After acquiring the force output ratio for each of the measuring points in step 64, the processing module 5 may assess force output accuracy for each foot of the user during the second period. In order to perform the assessment, the storage module 4 may store predetermined left-pedal force output reference information and predetermined right-pedal force output reference information therein. The predetermined left-pedal force output reference information indicates, among all of the measuring points in the measuring cycle, those of the measuring points at which the left foot of the user should apply a force on the left pedal 1. The predetermined right-pedal force output reference information indicates, among all of the measuring points in the measuring cycle, those of the measuring points at which the right foot of the user should apply a force on the right pedal 2.

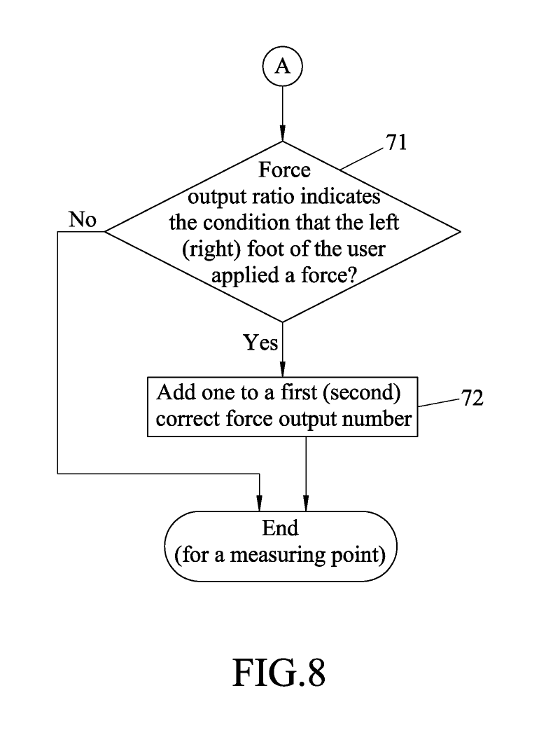

Referring to FIGS. 1, 2 and 8, in step 71, the processing module 5 determines, for each of the measuring points which are indicated by the predetermined left-pedal (right-pedal) force output reference information and at which the left (right) foot of the user should apply a force on the left pedal 1 (right pedal 2), whether the force output ratio corresponding to the measuring point indicates the condition that the left (right) foot of the user applied a force. For each of these measuring points, the flow goes to step 72 when the determination is affirmative, and terminates when otherwise.

In step 72, the processing module 5 adds one to a first (second) correct force output number, which may be stored in the storage module 4 and which may initially be zero. The flow then terminates for that measuring point.

Based on steps 71 and 72, the processing module 5 may calculate, based on the predetermined left-pedal force output reference information and the force output ratio for each of the measuring points, first accuracy that relates to the force output by the left foot of the user during the second time period, and calculate, based on the predetermined right-pedal force output reference information and the force output ratio for each of the measuring points, second accuracy that relates to the force output by the right foot of the user during the second time period.

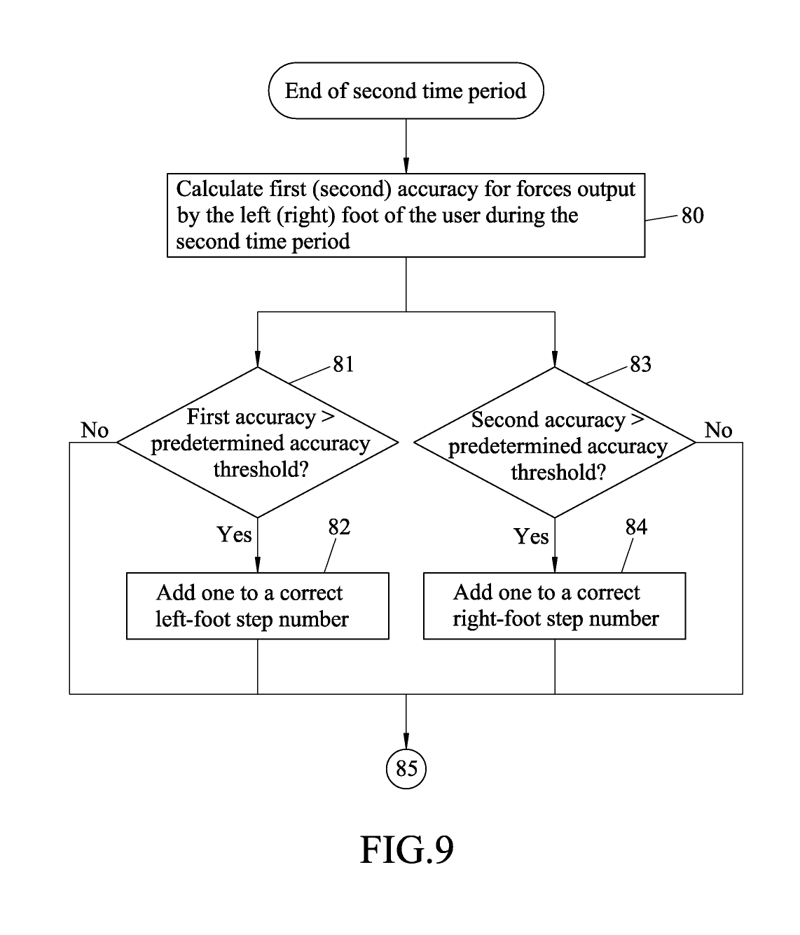

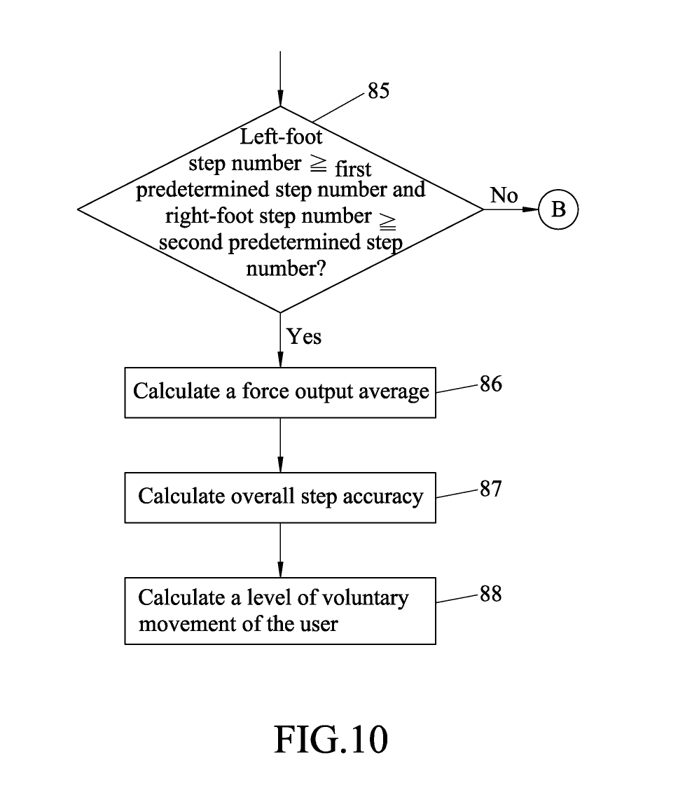

Referring to FIGS. 9 and 10, after the end of the second time period, the processing module 5 calculates the first (second) accuracy based on the first (second) correct force output number and those of the measuring points which are indicated by the predetermined left-pedal (right-pedal) force output reference information and at which the left (right) foot of the user should apply a force on the left pedal 1 (right pedal 2) (step 80).

After acquiring the first accuracy and the second accuracy during a single second time period, the processing module 5 may subsequently calculate overall step accuracy for the user during the entire rehabilitation process and assess a level of voluntary movement of the user according to steps 81 through 88.

In step 81, the processing module 5 determines whether the first accuracy is higher than a predetermined accuracy threshold, which may be stored in the storage module 4. The flow goes to step 82 when the determination is affirmative, and goes to step 85 when otherwise. In step 82, the processing module 5 adds one to a correct left-foot step number, which may be stored in the storage module 4 and which may initially be zero.

Similarly, in step 83, the processing module 5 determines whether the second accuracy is higher than the predetermined accuracy threshold. The flow goes to step 84 when the determination is affirmative, and goes to step 85 when otherwise. In step 84, the processing module 5 adds one to a correct right-foot step number, which may be stored in the storage module 4 and which may initially be zero.

In step 85, the processing module 5 determines whether a left-foot step number reaches a first predetermined step number and a right-foot step number reaches a second predetermined step number. It is noted that, in step 62, the processing module 5 may add one to each of the left-foot step number and the right-foot step number at the end of the second time period. Each of the left-foot step number and the right-foot step number may be stored in the storage module 4 and may initially be zero. The first and second predetermined step numbers may be stored in the storage module 4, and may be the same number in one embodiment. The flow goes to step 86 when the determination is affirmative, and goes back to step 62 for a next treading cycle when otherwise. In each treading cycle, the left foot of the user makes a full circle of action in taking a step, and the right foot of the user also makes a full circle of action in taking a step.

In step 86, the processing module 5 calculates a force output average based on the force output ratios corresponding to the measuring points in each treading cycle (corresponding to each repetition of the method steps 62 through 85).

In step 87, the processing module 5 calculates the overall step accuracy based on the correct left-foot step number, the correct right-foot step number, the first predetermined step number and the second predetermined step number. In this embodiment, the overall step accuracy is calculated by dividing a sum of the correct left-foot step number and the correct right-foot step number using a sum of the first predetermined step number and the second predetermined step number. It is noted that steps 86 and 87 are independent of each other, and the order of performing these two steps is not limited.

In step 88, the processing module 5 calculates a level of voluntary movement of the user based on the force output average and the overall step accuracy, and causes the display module 3 to display the level of voluntary movement. In this embodiment, the level of voluntary movement is calculated according to:

Vₘ=F_{LV}×W₁+Acc×W₂ (8),

where Vₘ represents the level of voluntary movement, F_{LV} represents the force output average, Acc represents the overall step accuracy, W₁ is a first predetermined weight, and W₂ is a second predetermined weight.

In summary, the rehabilitation equipment 100 according to this disclosure measures the forces output by the left-pedal driving module 11 and the right-pedal driving module 21 when the user is at the relaxing state and also when the user is at the exercising state, thereby obtaining information relating to the forces voluntarily output by the left foot and the right foot of the user. Then, the rehabilitation equipment 100 may determine whether the timings of the force output by the user are correct for each treading cycle (and thus also for each footstep), thereby effectively assessing the level of the voluntary movement of the user during the rehabilitation process. In addition, the display of the rehabilitation information, such as the force output ratio, the first accuracy, the second accuracy, the overall step accuracy, and the level of the voluntary movement may encourage the user to seek improvement, thereby motivating the user to return for the next rehabilitation session.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for assessing voluntary movement of a user during rehabilitation, comprising steps of:
(A) providing a rehabilitation equipment that includes:
a left foot pedal for operation by a left foot of the user;
a left-pedal driving module to drive movement of the left foot pedal for guiding the left foot of the user to take a step;
a left-pedal measuring module mounted to the left-pedal driving module and configured to measure a force output by the left-pedal driving module to drive movement of the left foot pedal;
a right foot pedal for operation by a right foot of the user;
a right-pedal driving module to drive movement of the right foot pedal for guiding the right foot of the user to take a step;
a right-pedal measuring module mounted to the right-pedal driving module and configured to measure a force output by the right-pedal driving module to drive movement of the right foot pedal; and
a processing module electrically coupled to the left-pedal measuring module and the right-pedal measuring module;
(B) measuring, by the left-pedal measuring module and the right-pedal measuring module during a first time period which has a length equaling that of a measuring cycle and in which both of the left foot of the user on the left foot pedal and the right foot of the user on the right foot pedal are at a relaxing state, the force output by the left-pedal driving module to generate first left-pedal force information corresponding to the first time period, and the force output by the right-pedal driving module to generate first right-pedal force information corresponding to the first time period;
(C) measuring, by the left-pedal measuring module and right-pedal measuring module during a second time period which has a length equaling that of the measuring cycle and in which both of the left foot of the user on the left foot pedal and the right foot of the user on the right foot pedal are at an exercising state, the force output by the left-pedal driving module to generate second left-pedal force information corresponding to the second time period, and the force output by the right-pedal driving module to generate second right-pedal force information corresponding to the second time period; and
(D) determining, by the processing module, a difference between the first left-pedal force information and the second left-pedal force information to generate left-foot force output information relating to a force output by the left foot of the user, and determining, by the processing module, a difference between the first right-pedal force information and the second right-pedal force information to generate right-foot force output information relating to a force output by the right foot of the user.

2. The method of claim 1, wherein the first left-pedal force information includes multiple sets of first-period left-pedal force data respectively corresponding to a plurality of measuring points which are points in time defined with respect to the measuring cycle, and the first right-pedal force information includes multiple sets of first-period right-pedal force data respectively corresponding to the measuring points;
wherein the second left-pedal force information includes multiple sets of second-period left-pedal force data respectively corresponding to the measuring points, and the second right-pedal force information includes multiple sets of second-period right-pedal force data respectively corresponding to the measuring points;
wherein the left-foot force output information includes multiple sets of left-pedal force difference data respectively corresponding to the measuring points, each of the sets of the left-pedal force difference data relating to a difference between one of the second-period left-pedal force data and one of the first-period left-pedal force data that correspond to a respective same one of the measuring points;
wherein the right-foot force output information includes multiple sets of right-pedal force difference data respectively corresponding to the measuring points, each of the sets of the right-pedal force difference data relating to a difference between one of the second-period right-pedal force data and one of the first-period right-pedal force data that correspond to a respective same one of the measuring points;
said method further comprising a step of:
(E) calculating, by the processing module for each of the measuring points, a force output ratio based on the corresponding one of the sets of the left-pedal force difference data and the corresponding one of the sets of the right-pedal force difference data;
wherein, for each of the measuring points, the force output ratio indicates one of a condition that the left foot of the user applied a force, a condition that the right foot of the user applied a force, and a condition that neither the left foot nor the right foot of the user applied a force.

3. The method of claim 2, wherein each of the sets of the first-period left-pedal force data includes a first-period left-pedal horizontal force value and a first-period left-pedal vertical force value, and each of the sets of the first-period right-pedal force data includes a first-period right-pedal horizontal force value and a first-period right-pedal vertical force value;
wherein each of the sets of the second-period left-pedal force data includes a second-period left-pedal horizontal force value and a second-period left-pedal vertical force value, and each of the sets of the second-period right-pedal force data includes a second-period right-pedal horizontal force value and a second-period right-pedal vertical force value;
wherein each of the sets of the left-pedal force difference data includes a left-pedal horizontal force difference value which is a difference between the first-period left-pedal horizontal force value of the corresponding one of the sets of the first-period left-pedal force data and the second-period left-pedal horizontal force value of the corresponding one of the sets of the second-period left-pedal force data, and a left-pedal vertical force difference value which is a difference between the first-period left-pedal vertical force value of the corresponding one of the sets of the first-period left-pedal force data and the second-period left-pedal vertical force value of the corresponding one of the sets of the second-period left-pedal force data;
wherein each of the right-pedal force difference data includes a right-pedal horizontal force difference value which is a difference between the first-period right-pedal horizontal force value of the corresponding one of the sets of the first-period right-pedal force data and the second-period right-pedal horizontal force value of the corresponding one of the sets of the second-period right-pedal force data, and a right-pedal vertical force difference value which is a difference between the first-period right-pedal vertical force value of the corresponding one of the sets of the first-period right-pedal force data and the second-period right-pedal vertical force value of the corresponding one of the sets of the second-period right-pedal force data;
wherein the step (E) includes, for each of the measuring points:
calculating a left-pedal horizontal force correction value based on the left-pedal horizontal force difference value that corresponds to the measuring point and a predetermined horizontal force threshold value that corresponds to the measuring point, a left-pedal vertical force correction value based on the left-pedal vertical force difference value that corresponds to the measuring point and a predetermined vertical force threshold value that corresponds to the measuring point, a right-pedal horizontal force correction value based on the right-pedal horizontal force difference value that corresponds to the measuring point and the predetermined horizontal force threshold value that corresponds to the measuring point, and a right-pedal vertical force correction value based on the right-pedal vertical force difference value that corresponds to the measuring point and the predetermined vertical force threshold value that corresponds to the measuring point;
calculating a left-pedal force correction value based on the left-pedal horizontal force correction value and the left-pedal vertical force correction value that correspond to the measuring point, and a right-pedal force correction value based on the right-pedal horizontal force correction value and the right-pedal vertical force correction value that correspond to the measuring point; and
calculating the force output ratio based on the left-pedal force correction value and the right-pedal force correction value that correspond to the measuring point.

4. The method of claim 2, wherein the rehabilitation equipment further includes a storage module that is electrically connected to the processing module and that stores predetermined left-pedal force output reference information that indicates, among all of the measuring points in the measuring cycle, those of the measuring points at which the left foot of the user should apply a force on the left pedal, and predetermined right-pedal force output reference information that indicates, among all of the measuring points in the measuring cycle, those of the measuring points at which the right foot of the user should apply a force on the right pedal;
said method further comprising, after the step (E), a step of (F) calculating, by the processing module, first accuracy relating to the force output by the left foot of the user based on the predetermined left-pedal force output reference information and the force output ratio for each of the measuring points, and second accuracy relating to the force output by the right foot of the user based on the predetermined right-pedal force output reference information and the force output ratio for each of the measuring points.

5. The method of claim 4, wherein the calculating the first accuracy includes:
determining, for each of those of the measuring points which are indicated by the predetermined left-pedal force output reference information and at which the left foot of the user should apply a force on the left pedal, whether the force output ratio corresponding to the measuring point indicates the condition that the left foot of the user applied a force;
upon determining, for each of those of the measuring points which are indicated by the predetermined left-pedal force output reference information and at which the left foot of the user should apply a force on the left pedal, that the force output ratio corresponding to the measuring point indicates the condition that the left foot of the user applied a force, adding one to a first correct force output number; and
calculating the first accuracy based on the first correct force output number and a number of those of the measuring points which are indicated by the predetermined left-pedal force output reference information and at which the left foot of the user should apply a force on the left pedal; and
wherein the calculating the second accuracy includes:
determining, for each of those of the measuring points which are indicated by the predetermined right-pedal force output reference information and at which the right foot of the user should apply a force on the right pedal, whether the force output ratio corresponding to the measuring point indicates the condition that the right foot of the user applied a force;
upon determining, for each of those of the measuring points which are indicated by the predetermined right-pedal force output reference information and at which the right foot of the user should apply a force on the right pedal, that the force output ratio corresponding to the measuring point indicates the condition that the right foot of the user applied a force, adding one to a second correct force output number; and
calculating the second accuracy based on the second correct force output number and those of the measuring points which are indicated by the predetermined right-pedal force output reference information and at which the right foot of the user should apply a force on the right pedal.

6. The method of claim 5, further comprising, after the step (F), steps of:
(G) determining whether the first accuracy is higher than an accuracy threshold;
(H) upon determining that the first accuracy is higher than the accuracy threshold, adding one to a correct left-foot step number;
(I) determining whether the second accuracy is higher than the accuracy threshold; and
(J) upon determining that the second accuracy is higher than the accuracy threshold, adding one to a correct right-foot step number.

7. The method of claim 6, wherein the step (C) further includes adding one to each of a left-foot step number and a right-foot step number, said method further comprising steps of:
(K) repeating the steps (C) through (J) until the left-foot step number reaches a first predetermined step number and the right-foot step number reaches a second predetermined step number;
(L) calculating, by the processing module, a force output average based on the force output ratios corresponding to the measuring points;
(M) calculating, by the processing module, an overall step accuracy based on the correct left-foot step number, the correct right-foot step number, the first predetermined step number and the second predetermined step number; and
(N) calculating, by the processing module, a level of voluntary movement of the user based on the force output average and the overall step accuracy.

8. A rehabilitation equipment comprising:
a left foot pedal for operation by a left foot of a user;
a left-pedal driving module to drive movement of said left foot pedal for guiding the left foot of the user to take a step;
a right foot pedal for operation by a right foot of the user;
a right-pedal driving module to drive movement of said right foot pedal for guiding the right foot of the user to take a step;
a left-pedal measuring module mounted to said left-pedal driving module, and used to measure, during a first time period which has a length equaling that of a measuring cycle and in which both of the left foot of the user on said left foot pedal and the right foot of the user on said right foot pedal are at a relaxing state, a force output by said left-pedal driving module to generate first left-pedal force information corresponding to the first time period, and to measure, during a second time period which has a length equaling that of the measuring cycle and in which both of the left foot of the user on said left foot pedal and the right foot of the user on said right foot pedal are at an exercising state, a force output by said left-pedal driving module to generate second left-pedal force information corresponding to the second time period;
a right-pedal measuring module mounted to said right-pedal driving module, and used to measure, during the first time period, a force output by said right-pedal driving module to generate first right-pedal force information corresponding to the first time period, and to measure, during the second time period, a force output by said right-pedal driving module to generate second right-pedal force information corresponding to the second time period; and
a processing module electrically connected to said left-pedal measuring module and said right-pedal measuring module for receiving the first left-pedal force information, the second left-pedal force information, the first right-pedal force information, and the second right-pedal force information, and configured to determine a difference between the first left-pedal force information and the second left-pedal force information to generate left-foot force output information relating to a force output by the left foot of the user, and determine a difference between the first right-pedal force information and the second right-pedal force information to generate right-foot force output information relating to a force output by the right foot of the user.

9. The rehabilitation equipment of claim 8, wherein the first left-pedal force information includes multiple sets of first-period left-pedal force data respectively corresponding to a plurality of measuring points which are points in time defined with respect to the measuring cycle, and the first right-pedal force information includes multiple sets of first-period right-pedal force data respectively corresponding to the measuring points;
wherein the second left-pedal force information includes multiple sets of second-period left-pedal force data respectively corresponding to the measuring points, and the second right-pedal force information includes multiple sets of second-period right-pedal force data respectively corresponding to the measuring points;
wherein the left-foot force output information includes multiple sets of left-pedal force difference data respectively corresponding to the measuring points, each of the sets of the left-pedal force difference data relating to a difference between one of the sets of the second-period left-pedal force data and one of the sets of the first-period left-pedal force data that correspond to a respective same one of the measuring points;
wherein the right-foot force output information includes multiple sets of right-pedal force difference data respectively corresponding to the measuring points, each of the sets of the right-pedal force difference data relating to a difference between one of the sets of the second-period right-pedal force data and one of the sets of the first-period right-pedal force data that correspond to a respective same one of the measuring points;
wherein said processing module is further configured to calculate, for each of the measuring points, a force output ratio based on the corresponding one of the sets of the left-pedal force difference data and the corresponding one of the sets of the right-pedal force difference data;
wherein, for each of the measuring points, the force output ratio indicates one of a condition that the left foot of the user applied a force, a condition that the right foot of the user applied a force, and a condition that neither the left foot nor the right foot of the user applied a force.

10. The rehabilitation equipment of claim 9, wherein each of the sets of the first-period left-pedal force data includes a first-period left-pedal horizontal force value and a first-period left-pedal vertical force value, and each of the sets of the first-period right-pedal force data includes a first-period right-pedal horizontal force value and a first-period right-pedal vertical force value;
wherein each of the sets of the second-period left-pedal force data includes a second-period left-pedal horizontal force value and a second-period left-pedal vertical force value, and each of the sets of the second-period right-pedal force data includes a second-period right-pedal horizontal force value and a second-period right-pedal vertical force value;
wherein each of the sets of the left-pedal force difference data includes a left-pedal horizontal force difference value which is a difference between the first-period left-pedal horizontal force value of the corresponding one of the sets of the first-period left-pedal force data and the second-period left-pedal horizontal force value of the corresponding one of the sets of the second-period left-pedal force data, and a left-pedal vertical force difference value which is a difference between the first-period left-pedal vertical force value of the corresponding one of the sets of the first-period left-pedal force data and the second-period left-pedal vertical force value of the corresponding one of the sets of the second-period left-pedal force data;
wherein each of the sets of the right-pedal force difference data includes a right-pedal horizontal force difference value which is a difference between the first-period right-pedal horizontal force value of the corresponding one of the sets of the first-period right-pedal force data and the second-period right-pedal horizontal force value of the corresponding one of the sets of the second-period right-pedal force data, and aright-pedal vertical force difference value which is a difference between the first-period right-pedal vertical force value of the corresponding one of the sets of the first-period right-pedal force data and the second-period right-pedal vertical force value of the corresponding one of the sets of the second-period right-pedal force data;
wherein said processing module is configured to calculate the force output ratio for each of the measuring points by, for each of the measuring points:
calculating a left-pedal horizontal force correction value based on the left-pedal horizontal force difference value that corresponds to the measuring point and a predetermined horizontal force threshold value that corresponds to the measuring point, a left-pedal vertical force correction value based on the left-pedal vertical force difference value that corresponds to the measuring point and a predetermined vertical force threshold value that corresponds to the measuring point, a right-pedal horizontal force correction value based on the right-pedal horizontal force difference value that corresponds to the measuring point and the predetermined horizontal force threshold value that corresponds to the measuring point, and a right-pedal vertical force correction value based on the right-pedal vertical force difference value that corresponds to the measuring point and the predetermined vertical force threshold value that corresponds to the measuring point;
calculating a left-pedal force correction value based on the left-pedal horizontal force correction value and the left-pedal vertical force correction value that correspond to the measuring point, and a right-pedal force correction value based on the right-pedal horizontal force correction value and the right-pedal vertical force correction value that correspond to the measuring point; and
calculating the force output ratio based on the left-pedal force correction value and the right-pedal force correction value that correspond to the measuring point.
